(19) United States
(12) Patent Application Publication
(10) Pub. No.: US 2025/0191803 A1
(43) Pub. Date: Jun. 12, 2025

(54) QUANTUM COMPUTING

(71) Applicant: Universal Quantum LTD, Brighton (GB)

(72) Inventors: Foni Raphaël Charles LEBRUN-GALLAGHER, Brighton (GB); Sebastian WEIDT, Brighton (GB); Winfried HENSINGER, Brighton (GB)

(21) Appl. No.: 18/959,338

(22) Filed: Nov. 25, 2024

Related U.S. Application Data
(63) Continuation of application No. PCT/GB2023/051422, filed on May 30, 2023.

(30) Foreign Application Priority Data
May 30, 2022 (GB) 2207948.7

(51) Int. Cl. G21K 1/093

(52) U.S. Cl. CPC G21K 1/093

(57) ABSTRACT

There is provided an ion trap comprising a first current source, a first pair of parallel wires forming a plane and having a space therebetween, each of the wires being connected to the first current source such that current flows in opposite directions along each of the parallel wires, a second current source; and a second pair of parallel wires arranged in the plane of the first pair of parallel wires and in the space between the first pair of parallel wires and being substantially perpendicular to the first pair of wires, each of the second pair of wires being connected to the second current source such that each of the second pair current flows in opposite directions along each of the second pair of parallel wires.

### CROSS-REFERENCE

This application is a continuation of International Application No. PCT/GB2023/051422, filed on May 30, 2023, which claims the benefit of United Kingdom (GB) Patent Application No. 2207948.7, filed on May 30, 2022, each of which are incorporated herein in their entirety by reference.

### BACKGROUND OF THE INVENTION

The present invention relates to improvements in or relating to quantum computing, and in particular, to improved magnetic field gradient generation in an ion trap quantum computer. Quantum computing in general, unlike so-called “classical computing”, relies on the quantum mechanical properties of particles or matter to produce or alter data. The data may be represented by quantum bits or “qubits”, which is a two state quantum mechanical system. Unlike classical computing, the qubit may be in superposition of quantum states. Another feature of quantum computing is the entanglement between qubits in which the state of one particle or atom is influenced by another particle or atom. Quantum mechanical qubits are able to encode information as combinations of zeros and ones simultaneously. Such properties open numerous complex numerical applications that are traditionally difficult for classical computers. Examples include artificial intelligence, image processing and recognition, cryptography, or secure communications and so on. Within an ion hyperfine electronic states (Zeeman split states) can be revealed by the use of a magnetic field and the different electron levels used as the different qubit states and electrons moved between the levels using microwave radiation or lasers.

### SUMMARY OF THE INVENTION

A magnetic field gradient is often used to produce multi-qubit gates as discussed in “Ion-Trap Quantum Logic Using Lon-Wavelength Radiation” by Florian Mintert et al Phys. Rev. Lett 87, 257904 29 Nov. 2001. Optimally the absolute value of the magnetic field is nulled around the ion position.

In A. Khromova et al., “Designer spin pseudomolecule implemented with trapped ions in a magnetic gradient,” Phys. Rev. Lett., vol. 108, no. 22, pp. 1-5, (2012) magnetic gradients have been generated using permanent magnets. However, the applicability of this to large scale quantum computers is limited as they cannot be switched on or off.

The use of a coil electromagnet as described in J. Welzel et al., “Spin and motion dynamics with zigzag ion crystals in transverse magnetic gradients,” J. Phys. B At. Mol. Opt. Phys., vol. 52, no. 2, p. 025301, (2019) allows the magnetic field to be switched on and off but the magnetic field around the ion is not nulled thereby reducing the performance of quantum gates.

Therefore there is a desire to provide an improved ion trap with a magnetic field gradient in which the magnetic field is nulled around the ion position and which can be switched on and off.

In one aspect disclosed herein is an ion trap comprising: a first current source; a first pair of parallel wires forming a plane and having a space therebetween, each of the wires being connected to the first current source such that current flows in opposite directions along each of the parallel wires; a second current source; and a second pair of parallel wires arranged in the plane of the first pair of parallel wires and in the space between the first pair of parallel wires and being substantially perpendicular to the first pair of wires, each of the second pair of wires being connected to the second current source such that each of the second pair current flows in opposite directions along each of the second pair of parallel wires, wherein the magnetic field generated by the current from the first current source through the first pair of parallel wires, at a centre point of the first pair of parallel wires and the second pair of parallel wires, is opposite in direction from the magnetic field generated by the current from the second current source through the second pair of parallel wires. In some embodiments, the space between the first pair of parallel wires is in the range 100-10,000 μm. In some embodiments, each of the first pair of parallel wires comprises a plurality of wires. In some embodiments, each of the second pair of parallel wires comprises a plurality of wires. In some embodiments, the current source comprises a first current source for the first pair of parallel wires and a second current source for the second pair of parallel wires. In some embodiments, the space between the second pair of parallel wires is in the range 10-1,000 μm. In some embodiments, the second pair of parallel wires are formed from a U shaped deformation in a first wire of the first pair of parallel wires, with the branches of the U forming the second pair of wires. In some embodiments, the second wire of the first pair of parallel wires is thinner adjacent to the U shaped deformation. In some embodiments, a first wire of the second set of parallel wires is formed from a U shape of wire, the two branches of the U lying parallel to the first pair of parallel wires and the bridge of the U forming the first wire of the second set of parallel wires and wherein a second wire of the second set of parallel wires is formed from a U shape of wire, the two branches of the U lying parallel to the first pair of parallel wires and the bridge of the U forming the second wire of the second set of parallel wires. In some embodiments, a first wire of the second set of parallel wires is formed from a U shape of wire, the bridge of the wire forming the first wire of the second set of parallel wires and the branches lying perpendicular to the plane of the first and second set of parallel wires and wherein a second wire of the second set of parallel wires is formed from a U shape of wire, the bridge of the wire forming the second wire of the second set of parallel wires and the branches lying perpendicular to the plane of the first and second set of parallel wires. In some embodiments, each of the first and second parallel wires is formed of an electrically conductive material. In some embodiments, each of the first and second parallel wires has a rectangular cross section. In some embodiments, the second current source is the first current source. In some embodiments, the ion trap is a surface ion trap.

In an aspect disclosed herein is a method of generating a magnetic field comprising providing an ion trap wherein the current flowing in the first pair of parallel wires, from the first current source, generates a magnetic field which, at a centre point of both the first pair of parallel wires and the second pair of parallel wires, is opposite in direction from the magnetic field generated by the current in the second pair of parallel wires from the second current source. In some embodiments, the magnetic field at a position 10-1000 μm above the centre point between the first pair of parallel wires and the second pair of parallel wires is less than 10 mT. In some embodiments, the magnetic field gradient at the centre point between the first pair of parallel wires and the second pair of parallel wires, in a direction parallel to the first pair of parallel wires is in the range 10-10,000 T/m. In some embodiments, the magnetic field gradient at the centre point between the first pair of parallel wires and the second pair of parallel wires, in a direction parallel to the first pair of parallel wires is in the range 100-1000 T/m. In some embodiments, the gradient of the component of the magnetic field in a direction parallel to the first pair of parallel wires, along a direction parallel to the first pair of parallel wires, at the centre point between the first pair of parallel wires and the second pair of parallel wires, is greater than ±100 T/m. In some embodiments, the method comprises generating a magnetic field and providing an ion to suspend above at least a part of the ion trap. In some embodiments, the gradient of the magnetic field magnitude along a direction parallel to the first pair of parallel wires at the centre point between the first pair of parallel wires and the second pair of parallel wires is greater than ±100 T/m.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 depicts a current configuration according to the present invention;

FIG. 2 depicts an arrangement of wires according to the present invention;

FIG. 3 depicts and alternative arrangement of wires according to the present invention; and

FIG. 4 depicts the magnetic field generated by wires according to the invention.

### DETAILED DESCRIPTION OF THE INVENTION

According to the invention there is provided an ion trap comprising a first current source, a first pair of parallel wires forming a plane and having a space therebetween, each of the wires being connected to the first current source such that current flows in opposite directions along each of the parallel wires, a second current source and a second pair of parallel wires arranged in the plane of the first pair of parallel wires and in the space between the first pair of parallel wires and being perpendicular to the first pair of wires, each of the second pair of wires being connected to the second current source such that each of the second pair current flows in opposite directions along each of the second pair of parallel wires, wherein the magnetic field generated by the current from the first current source through the first pair of parallel wires, at a centre point of the first pair of parallel wires and the second pair of parallel wires, is opposite in direction from the magnetic field generated by the current from the second current source through the second pair of parallel wires. The current in the second pair of wires generates a magnetic field gradient along a direction parallel to the first pair of wires. The magnetic field generated by the current in the first pair of wires can be used to null the absolute value of the magnetic field at the centre position between the first and second pairs of parallel wires. The component of the magnetic field gradient in a direction parallel to the first wires at the centre point between the first and second pairs of parallel wires should be maximised but the absolute value of the magnetic field is substantially nulled. The gradient of the magnetic field in a direction parallel to the first pair of parallel wires, along a direction parallel to the first pair of parallel wires, at the centre point between the first pair of parallel wires and the second pair of parallel wires, is greater than ±100 T/m. The ion is suspended above the wires at a height of 10-1000 μm. The ion is generally between 1 and 500 μm offset from the centre point between the first and second pairs of parallel wires.

The magnetic field at the centre point between the pairs of parallel wires is substantially nulled, although there remains a gradient in the component of the magnetic field parallel to the first wires along a direction parallel to the first wires. The ion position is above the wires and slightly offset from the centre position.

Put another way, the addition of the first wires (to the second wires) does not affect the magnetic field gradient along a direction parallel to the first wires, but it nulls the magnetic field at the centre position.

The ion trap may be a microfabricated ion trap, in particular a surface ion trap. However, a multi-pole ion trap, for example a quadrupole or octupole, could also be used.

The space between the first pair of parallel wires is preferably in the range 100-10,000 μm and each of the first pair of parallel wires may comprise a plurality of wires. The plurality of wires may be located within the same plane as the first and second wires or each may be in parallel planes either side of the second set of wires. The space between the second pair of parallel wires is preferably in the range 10-1,000 μm.

Through use of the invention the magnetic field at the centre point between the first pair of parallel wires and the second pair of parallel wires is nulled and preferably less than 1 mT. The magnetic field gradient at the ion position which is 10-1000 μm above the centre point between the first pair of parallel wires and the second pair of parallel wires, in a direction parallel to the first pair of parallel wires is in the range 10-10,000 T/m and preferably in the range 100-1000 T/m. There may also be a magnetic field gradient at the centre point between the first pair of parallel wires and the second pair of parallel wires in a direction parallel to the second pair of parallel wires and in a direction perpendicular to both the first and second pair of parallel wires.

There may be a single current source for both pairs of wires or there may be a current source for each of the pairs of wires. The second pair of parallel wires are formed from a U shaped deformation in a first wire of the first pair of parallel wires, with the branches of the U forming the second pair of wires. The arrangement is advantageously easy to manufacture. The second wire of the first pair of parallel wires is generally thinner adjacent to the U shaped deformation to accommodate the U shape.

Alternatively a first wire of the second set of parallel wires is formed from a U shape of wire with the two branches of the U lying parallel to the first pair of parallel wires and the bridge of the U forming the first wire of the second set of parallel wires. A second wire of the second set of parallel wires is formed from a U shape of wire, the two branches of the U lying parallel to the first pair of parallel wires and the bridge of the U forming the second wire of the second set of parallel wires.

Alternatively a first wire of the second set of parallel wires is formed from a U shape of wire, the bridge of the wire forming the first wire of the second set of parallel wires and the branches lying perpendicular to the plane of the first and second set of parallel wires and wherein a second wire of the second set of parallel wires is formed from a U shape of wire, the bridge of the wire forming the second wire of the second set of parallel wires and the branches lying perpendicular to the plane of the first and second set of parallel wires.

For ease of fabrication the wires generally have a rectangular cross section although the wires could have any cross section.

According to the invention there is provided trapped ion quantum technology comprising a surface ion trap as described above.

According to the invention there is provided a method of generating a magnetic field comprising: providing an ion trap as described above and wherein the current flowing in the first pair of parallel wires, from the first current source, generates a magnetic field which, at a centre point of both the first pair of parallel wires and the second pair of parallel wires, is opposite in direction from the magnetic field generated by the current in the second pair of parallel wires from the second current source.

According to the invention there is provided a method of trapping an ion comprising a method of generating a magnetic field as described above and providing an ion to suspend above the ion trap.

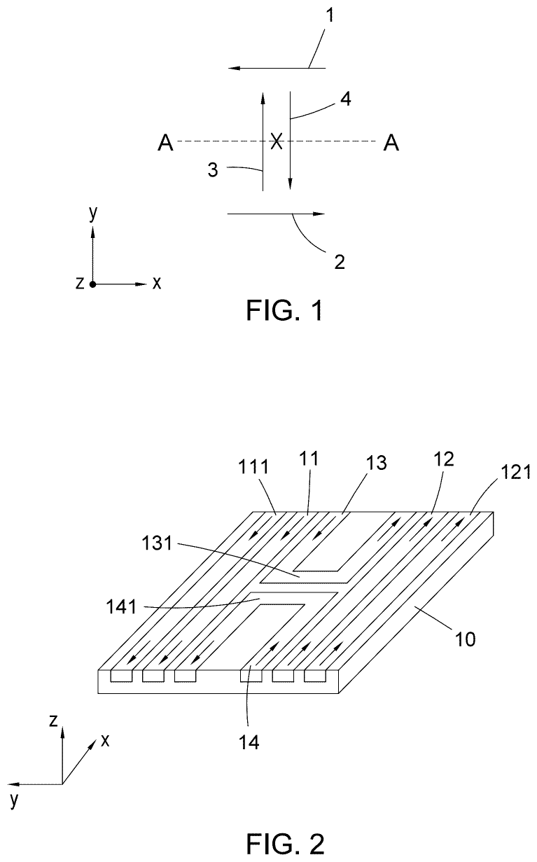

FIG. 1 depicts some currents according to the invention which can be used to generate a magnetic field at the ion position, which is above the plane of the wires at the position marked X, and also generate a magnetic field gradient along the dashed line marked A-A. FIG. 1 depicts a first pair of parallel wires 1, 2, and a second pair of wires 3, 4. The second pair of wires 3, 4 have anti-parallel currents which generate a magnetic field which varies in the x direction along the A-A line. The magnetic field generated by these wires also varies in the z direction but is constant in the y direction.

A first pair of wires runs perpendicular to the second pair of wires and also have anti-parallel currents. These also generate a magnetic field around them. This magnetic field is used to adjust the absolute value of the magnetic field magnitude at the ion position around X such that it is minimal (preferably in the range 0.1-3 mT). The ion is generally at a position slightly above the parallel wires. There is therefore a magnetic field gradient at the ion position but minimal absolute magnetic field. At the centre point between both pairs of parallel wires the magnetic field magnitude will be substantially nulled. However, at the ion position, approximate 1-500 μm offset from the centre and at a height of 10-10,000 μm above the plane of the wires there will be a minimal magnetic field.

The first pair of wires is connected to a first current source and the second pair of wires is connected to a second current source. The current in the first pair of wires, and therefore the strength of the surrounding magnetic field, is controlled by the first current source. The current in the second pair of wires, and therefore the strength of the surrounding magnetic field, is controlled by the second current source.

The current output by the first current source can be adjusted to substantially null the magnetic field at the centre point (indicated by X in FIG. 1) of the first pair of wires and the second pair of wires. At this centre point there may be a magnetic field gradient, but due to the presence of the first pair of wires, the magnetic field is substantially reduced, or null.

FIG. 2 depicts a specific arrangement of copper wires arranged in a substrate 10 according to the invention. In this embodiment there is a first pair of wires 11, 12 within a plane and having anti-parallel currents running therethrough from a first current source. The distance between these wires is 1000 μm, but could be in the range 100-10,000 μm. In this embodiment there is an additional pair of first wires 111, 121, in the same plane as the first wires and running parallel to the first wires and positioned outside the first pair of wires. The additional pair of first wires is also connected to the first current source and the current in each of these wires runs in the same directions as the first pair of wires and the current in these wires serves to increase the magnetic field, thereby enabling larger magnetic field gradients to be used.

A second pair of wires 13, 14 is also shown in FIG. 2 and these are located in the same plane as the first pair of wires. The second pair of wires are U shaped with the bridge of the U 131, 141 lying substantially perpendicular to the first pair of wires. The branches of the U lie substantially perpendicular to the first pair of wires. The bridges of the U 131, 141 generates a magnetic field gradient along the x direction. The distance between the bridges of the U 131, 141 is 100 μm and preferably in the range 10-500 μm. The ion position is located near the centre of the both the first wires and the bridges of the second pair of wires. The ion is generally positioned 100 μm above the plane of the wires, but could be in the range 10-1000 μm.

The current in the first and second pair of wires is selected such that the magnetic field from the first pair of wires nulls the absolute value of the magnetic field at the centre point of the first pair of wires and the second pair of wires. The magnetic field at the ion position will therefore be substantially reduced.

For ease of manufacture the wires generally have a rectangular cross section with a depth of approximately 15 μm. However, the thickness could be in the range 100 nm to 1000 μm. The wires are often manufactured using electroplating. The magnetic field gradient at the ion position 10-1000 μm above position X is generally in the range 100-1000 T/m.

The first pair of parallel wires is connected to a first current source and the second pair of parallel wires is connected to a second current source. The current source generates an anti-parallel current in each of the pairs of wires. A current of approximately 10 A (preferably in the range 1-100 A) in each of the pairs of wires is used to generate the magnetic fields. Alternatively the first current source may generate a first level of current and the second current source may generate a second level of current such that the magnetic field gradient near the ion position is maximised but the magnetic field is substantially nulled.

Although two current sources could be used, a single current source could alternatively be used. Another alternative is the use of one or more voltage sources.

Further pairs of wires can be used if necessary. The additional pairs of wires are usually within the same plane as the first pair of wires and second pair of wires. However, they could be in a plane parallel to the plane of the first and second pair of wires. As an example, the first pair of parallel wires may comprise a plurality of wires. As a further example the second pair of parallel wires may comprise a plurality of wires.

In an alternative embodiment the first pair of wires is in a different, but parallel, plane from the second pair of wires. Additionally, the individual wires of each pair of wires could themselves be in additional planes relative to each other.

For ease, the first pair of wires may be connected at one end to generate a loop. Although the wires are described as being formed of copper any electrically conductive material can be used.

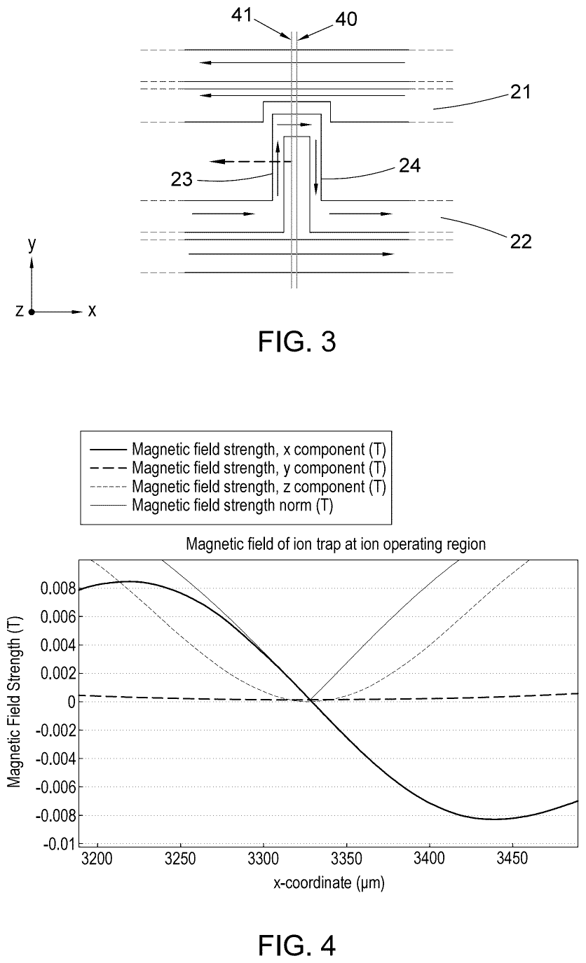

A second arrangement of wires is depicted in FIG. 3. Here the second pair of wires 23, 24 is formed in a U shape from one of the first pair of wires 21, 22. Advantageously this formation tessellates and is easily reproducible.

Similarly to the arrangement in FIG. 2, the magnetic field at the centre point of the first pair of wires and the second pair of wires is substantially null. A centre line of the second pair of wires is shown by line 40 and the position of the ion, slightly offset from the centre line is depicted at line 41. The direction of the magnetic field gradient at the ion location (41), that is offset from the centre line, is depicted in a dashed arrow in FIG. 3.

The first pair of wires have a width of approximately 500 μm (preferably 50 μm-1,000 μm), except for the portion adjacent to the U shaped deformation. If these wires are made narrower the resistance increases and the power consumption therefore also increases, which can create heat dissipation problems.

The second pair of wires has a width of 50 μm, though it can be in a range 10-200 μm. The narrower the second pair of wires is the sharper the magnetic field gradient which can be obtained.

The magnetic fields generated by the arrangement depicted in FIG. 3 are depicted in FIG. 4. As can be seen the y component of the magnetic field along an x direction is substantially zero. The z component of the magnetic field along an x direction has a turning point around the ion position and the gradient of the magnetic field in the x direction is maximised around the ion position whereas the overall magnetic field is nulled. In this example the gradient of the magnetic field in the x direction along the x axis is approximately 160 T/m, although it could be any value greater than 100 T/m.

Various further aspects and embodiments of the present invention will be apparent to those skilled in the art in view of the present disclosure.

The term “and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments. It is not limited to the disclosed embodiments and that alternative embodiments could be constructed without departing from the scope of the invention as defined in the appended claims.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1.-22. (canceled)

23. An ion trap comprising:
a current source; and
a plurality of wires connected to the current source, wherein the plurality of wires is configured to have current flow in at least two directions along the plurality of wires, and
wherein the current flow in at least two directions is configured to generate a magnetic field gradient comprising a region of substantially null magnetic field.

24. The ion trap of claim 23, wherein the plurality of wires is disposed along a first axis, and wherein at least one wire of the plurality of wires comprises a portion disposed along a second axis intersecting the first axis.

25. The ion trap of claim 24, wherein the portion of the at least one wire is disposed between a pair of wires of the plurality of wires.

26. The ion trap of claim 25, wherein the pair of wires are separated by about 10 μm to about 10,000 μm.

27. The ion trap of claim 25, wherein the pair of wires comprises the at least one wire.

28. The ion trap of claim 24, wherein at least two wires of the plurality of wires comprise a portion disposed along the second axis.

29. The ion trap of claim 28, wherein the at least two wires comprise a U-shaped portion.

30. The ion trap of claim 29, wherein a bridging portion of the U-shaped portion of each of the at least two wires is disposed along the second axis.

31. The ion trap of claim 23, wherein the current source comprises a first current source and a second current source.

32. The ion trap of claim 31, wherein the first current source is configured to provide an electrical current in a first direction, and wherein the second current source is configured to provide an electrical current in a second direction.

33. The ion trap of claim 23, wherein at least one wire of the plurality of wires comprises a U-shaped portion.

34. The ion trap of claim 33, wherein a bridging portion of the U-shaped portion comprises a reduced thickness.

35. The ion trap of claim 23, wherein the plurality of wires comprises a rectangular cross-section.

36. The ion trap of claim 35, wherein the rectangular cross section comprises a thickness of about 100 nm to about 2,000 μm.

37. The ion trap of claim 23, wherein the plurality of wires is coplanar.

38. The ion trap of claim 23, wherein the region of substantially null magnetic field comprises a magnetic field strength of less than about 10 mT.

39. The ion trap of claim 23, wherein the region of substantially null magnetic field is about 10 μm to about 1,000 μm above a surface of the ion trap.

40. The ion trap of claim 23, wherein the magnetic field gradient comprises a gradient of about 10 T/m to about 10,000 T/m.

41. The ion trap of claim 23, wherein the plurality of wires comprise copper.

42. The ion trap of claim 23, wherein the current source is configured to switch the magnetic field gradient on and off.
